(19) United States
(12) Patent Application Publication
(10) Pub. No.: US 2024/0296369 A1
(43) Pub. Date: Sep. 5, 2024

(54) NETWORK MANAGEMENT FOR MULTI-VENDOR HYBRID QUANTUM-CLASSICAL NETWORKS

(71) Applicants: AT&T Intellectual Property I, L.P., Atlanta, GA (US); AT&T Mobility II LLC, Atlanta, GA (US)

(72) Inventors: Mark Stockert, San Antonio, TX (US); Thomas Routt, Sequim, WA (US); Jerry Robinson, Middletown, NJ (US)

(21) Appl. No.: 18/178,485

(22) Filed: Mar. 3, 2023

(51) Int. Cl. G06N 10/80; G06N 20/00; H04L 9/00

(52) U.S. Cl. CPC G06N 10/80; G06N 20/00; H04L 9/008

(57) ABSTRACT

A method for managing multi-vendor fifth generation/sixth generation and next-generation hybrid quantum-classical networks includes determining a proposed network compute cloud configuration for a hybrid quantum-classical telecommunications network supported by a plurality of cloud environments, determining a protocol that is required to implement the proposed network compute cloud configuration, based on a topology of the hybrid quantum-classical telecommunications network, and delegating a quantum function of the proposed network compute cloud configuration among the plurality of cloud environments, using the protocol.

The present disclosure relates generally to cellular networks, and relates more particularly to devices, non-transitory computer-readable media, and methods for managing multi-vendor fifth generation/sixth generation and next-generation hybrid quantum-classical networks.

### BACKGROUND

Quantum computation stores information as quantum bits (or “qubits”), which are quantum generalizations of classical bits. Qubits can be represented as a two-to-n-level quantum system based on, for example, electronic/photonic spin and polarization, where: (1) the state of a qubit is a phase vector |ψ [symbol] (mathematical description of a quantum system, a complex-valued probability amplitude and the probabilities for possible results of measurements made on the system) in a linear superposition of states such as |ψ [symbol] =α|0 [symbol] +β|1 [symbol] ; (2) state vectors |0 [symbol] and |1 [symbol] are physical eigenstates of the logical observable and form a computational basis spanning a two-to-n dimensional Hilbert space (i.e., inner product space of two or more vectors, equal to the vector inner product between two or more matrix representations of those vectors containing |ψ [symbol] ; and (3) a collection of qubits comprises a multi-particle quantum system.

Quantum computation can pursue all computational trajectories simultaneously based on quantum superposition (i.e., integration of all states between 0 and 1), whereas classical computation proceeds in a serial fashion. Quantum logic gates form basic quantum circuits that operate on qubits, are reversible with a few exceptions (unlike classical logic gates), and are unitary operators, described as unitary matrices relative to basis states. Quantum algorithms utilize quantum circuit gates to manipulate states of quantum systems, just as classical algorithms utilize classical logic gates (represented as a sequence of Boolean gates) to perform classical (non-quantum) computational operations.

### SUMMARY

The present disclosure broadly discloses methods, computer-readable media, and systems for managing multi-vendor fifth generation/sixth generation and next-generation hybrid quantum-classical networks. In one example, a method performed by a processing system including at least one processor includes determining a proposed network compute cloud configuration for a hybrid quantum-classical telecommunications network supported by a plurality of cloud environments, determining a protocol that is required to implement the proposed network compute cloud configuration, based on a topology of the hybrid quantum-classical telecommunications network, and delegating a quantum function of the proposed network compute cloud configuration among the plurality of cloud environments, using the protocol.

In another example, a non-transitory computer-readable medium may store instructions which, when executed by a processing system including at least one processor, cause the processing system to perform operations. The operations may include determining a proposed network compute cloud configuration for a hybrid quantum-classical telecommunications network supported by a plurality of cloud environments, determining a protocol that is required to implement the proposed network compute cloud configuration, based on a topology of the hybrid quantum-classical telecommunications network, and delegating a quantum function of the proposed network compute cloud configuration among the plurality of cloud environments, using the protocol.

In another example, a device may include a processing system including at least one processor and a non-transitory computer-readable medium storing instructions which, when executed by the processing system, cause the processing system to perform operations. The operations may include determining a proposed network compute cloud configuration for a hybrid quantum-classical telecommunications network supported by a plurality of cloud environments, determining a protocol that is required to implement the proposed network compute cloud configuration, based on a topology of the hybrid quantum-classical telecommunications network, and delegating a quantum function of the proposed network compute cloud configuration among the plurality of cloud environments, using the protocol.

### BRIEF DESCRIPTION OF THE DRAWINGS

The teachings of the present disclosure can be readily understood by considering the following detailed description in conjunction with the accompanying drawings, in which:

FIG. 1A illustrates an example system in which examples of the present disclosure for managing multi-vendor fifth generation/sixth generation and next-generation hybrid quantum-classical networks may operate;

FIG. 1B illustrates an example of the system of FIG. 1A in which the optimizer has distributed a plurality of virtual network functions and a plurality of containerized network functions to a plurality of quantum-classical compute applications in a plurality of external and internal cloud environments;

FIG. 2 illustrates a flowchart of an example method for managing multi-vendor fifth generation/sixth generation and next-generation hybrid quantum-classical networks, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for managing multi-vendor fifth generation/sixth generation and next-generation hybrid quantum-classical networks. As discussed above, quantum computation stores information as quantum bits (or “qubits”), which are quantum generalizations of classical bits. Qubits can be represented as a two-to-n-level quantum system based on, for example, electronic/photonic spin and polarization, where: (1) the state of a qubit is a phase vector |ψ [symbol] (mathematical description of a quantum system, a complex-valued probability amplitude and the probabilities for possible results of measurements made on the system) in a linear superposition of states such as |ψ [symbol] =α|0 [symbol] +β|1 [symbol] ; (2) state vectors |0 [symbol] and |1 [symbol] are physical eigenstates of the logical observable and form a computational basis spanning a two-to-n dimensional Hilbert space (i.e., inner product space of two or more vectors, equal to the vector inner product between two or more matrix representations of those vectors containing |ψ [symbol] ; and (3) a collection of qubits comprises a multi-particle quantum system.

Quantum computation can pursue all computational trajectories simultaneously based on quantum superposition (i.e., integration of all states between 0 and 1), whereas classical computation proceeds in a serial fashion. Quantum logic gates form basic quantum circuits that operate on qubits, are reversible with a few exceptions (unlike classical logic gates), and are unitary operators, described as unitary matrices relative to basis states. Quantum algorithms utilize quantum circuit gates to manipulate states of quantum systems, just as classical algorithms utilize classical logic gates (represented as a sequence of Boolean gates) to perform classical (non-quantum) computational operations.

Hybrid quantum-classical networks operate in parallel, where the classical networks and the quantum networks may be topologically identical. Quantum routers have been designed and prototyped, and, though not yet commercially available, it is not unreasonable to assume that quantum routers and repeaters will be commercially available in the near term given the pace of innovation in the quantum technology field. Initial quantum networks have been built and are in use for quantum key distribution (QKB) and as research test beds.

Thus, although hybrid quantum-classical networks have not yet reached the state of the art where network management systems have been designed or built, early work is progressing on network elements and protocols for communication between nodes. Hybrid quantum-classical network technology will reach a point in a few years where the first commercial hybrid quantum-classical networks will be built and begin to carry traffic. The performance and security advantages of hybrid quantum-classical networks may prove advantageous to public safety agencies and first responders, who rely on highly available, low-latency communications and network infrastructures and location-based situational awareness when responding to routine, emergency, and disaster scenarios in real time.

Hybrid quantum-classical networks can transmit and store entangled qubits, among other unique quantum properties. Additionally, hybrid quantum-classical networks are subject to quantum errors in the network, such as loss, dephasing, depolarization, and the like. Sixth generation (6G) mobile networks will increasingly require quantum and hybrid quantum-classical communications to interconnect a plurality of end-to-end quantum and hybrid quantum-classical networked application resources (e.g., application programs, application programming interfaces or APIs, application servers, security servers, data repositories/lakes, routers, switches, load balancers, links, and the like).

Emerging 6G applications for tactile networks, Internet of Things (IoT), digital twins, and the like will greatly expand network traffic demand during wide area disasters and emergencies. 6G networks will require hyper-synchronization of multiple parallel flows to multiple devices supporting synchronized parallel media streams that originate from multiple network endpoints and midpoints.

Most emergencies occur without warning and almost always require rapid and seamless response with little to no room for error. Timely, multidisciplinary, coordinated responses across agency lines are critical to protecting communities and citizens. Whether the emergency is a fire, a natural disaster (e.g., a hurricane, an earthquake, a forest fire, a flood, a commercial disaster, or the like), a vehicular accident, a search and rescue operation, an act of terrorism, or pursuit of criminal suspects, highly available, low latency networks, real-time data collection, real-time three-dimensional location-based situational awareness, and actionable analytics are needed to enable successful response by first responders.

During wide area disasters or emergencies, there is a potentially large demand for network (e.g., fifth generation or 5G/6G and next-generation quantum distributed network) capacity, as well as for quantum federated learning and quantum distributed compute and/or memory capacity. The capacity demanded during such situations may far exceed the engineered network capacity. Moreover, damage to the network infrastructure from the disaster or emergency may further reduce network capacity (e.g., compute and/or memory capacity). Thus, rationed capacity with priority services and traffic throttling (e.g., overload controls, network management, and/or other techniques) may be implemented locally in areas where the network capacity struggles to meet the demand. Hybrid quantum-classical networks will require management and optimization to perform optimally in such situations.

Examples of the present disclosure optimize the management of multi-vendor fifth generation/sixth generation and next-generation hybrid quantum-classical networks. In one example, network overload in multi-vendor fifth generation/sixth generation and next-generation hybrid quantum-classical networks may be mitigated by shifting network traffic to third party distributed quantum-classical public and/or private cloud compute, storage, and learning environments.

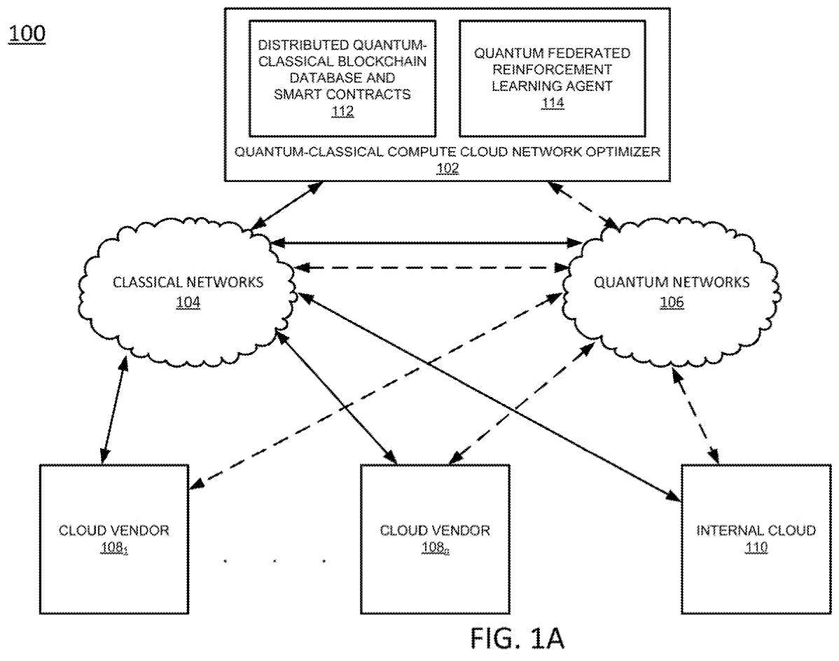

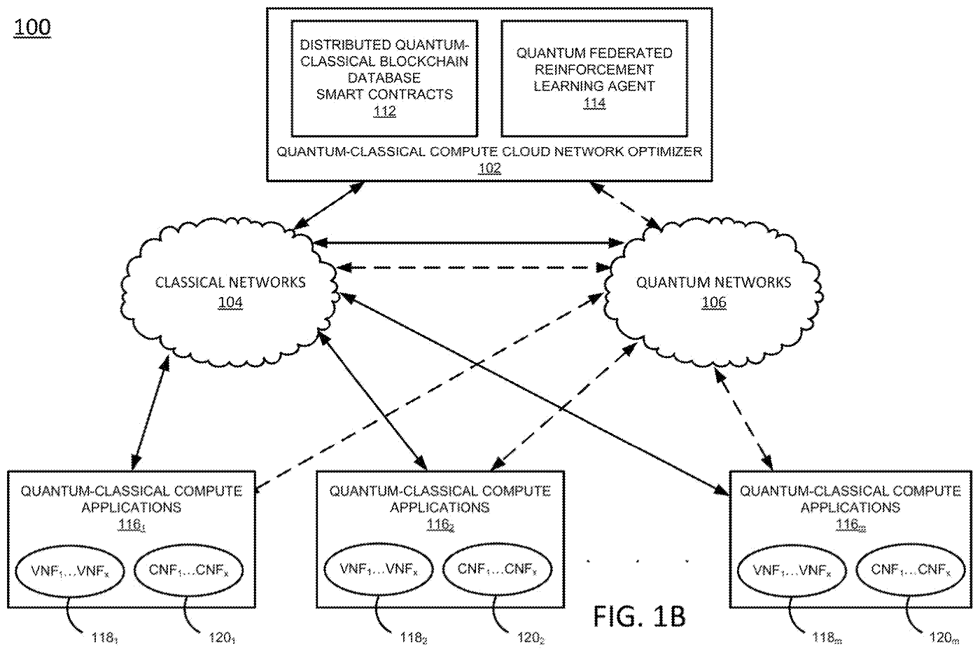

Further examples of the present disclosure provide efficient management, security, and distribution of network functions and delegated compute, storage, and applications, some of which are impossible to provide in classical network environments, to a plurality of quantum-classical cloud computing external networks and internal networks. For instance, classical compute and storage certification of data deletion on untrusted devices is currently impossible (i.e., there is no way to prevent an untrusted device from keeping even an encoded text in memory indefinitely, or until the underlying encryption scheme can be broken). However, quantum compute, storage, and application certified data deletion on untrusted devices is possible, for instance through use of cryptographic primitives with certified deletion (where the primitives allow a party holding a quantum ciphertext to generate a classical certificate attesting that an encrypted plaintext has been information theoretic deleted). These and other aspects of the present disclosure are discussed in greater detail below in connection with the examples of FIGS. 1A-3.

Within the context of the present disclosure, “quantum-classical cloud computing” is understood to refer to the delivery of quantum-classical compute and storage, applications, tools, databases, software, and other services over the Internet or an intranet. “Cloud” computing refers to the fact that the information being accessed is stored remotely in the cloud (i.e., in a virtual space). Cloud computing can be public, private, or both. Public cloud services are typically provided over the Internet, while private cloud services are typically restricted to specific customers or subscribers. Hybrid cloud services may combine elements of public and private cloud services.

Within the context of the present disclosure “delegated” compute or storage is understood to refer to the task of assigning compute or storage on hidden data to an untrusted third party by a known party, while preserving the privacy of hidden data and compute and storage operations from the untrusted third party. Protocols under this functionality are commonly referred to as “client-server protocols.” “Delegated quantum computation” (or DQC) protocols involve partially classical or fully classical clients delegating a quantum computation to one or more quantum computers. All DQC protocols involve three main stages: a preparation stage, a computation stage, and an output correction stage. The roles of the client and the server in these different stages may differ according to the type of communication. The DQC protocols differ in the types of communication channels required. In this context, an “online” link indicates that the link is used throughout the protocol. An “offline” link indicates that the link is used only at the start or the end of the protocol (e.g., a one-time use channel), and that there is no continuous exchange of information across the link. Quantum communication links are used to transfer quantum states and information, while classical communication links are used for the exchange of classical information.

To further aid in understanding the present disclosure, FIG. 1A illustrates an example system 100 in which examples of the present disclosure for managing multi-vendor fifth generation/sixth generation and next-generation hybrid quantum-classical networks may operate. The system 100 may comprise all or part of a 5G/6G (and/or next-generation) quantum-classical hybrid network. The hybrid quantum-classical network may comprise an entirety of a communications network, or may comprise only a subnet (e.g., a local, regional, national, international, satellite, or the like subnet) of a larger communications network. Network paths may include 6G RAN access nodes and user endpoints (UEs) with quantum channels.

The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 comprises a quantum-classical compute cloud network optimizer (or, simply, “optimizer”) 102 that manages dual or tandem classical networks 104 and quantum networks 106 that operate in parallel.

In one example, the classical networks 104 and the quantum networks 106 may be topologically identical. Moreover, classical channels and quantum channels may co-exist in network nodes. The classical networks 104 and quantum networks 106 may be connected to one or more external (vendor) cloud computing environments 108₁-108ₙ (hereinafter individually referred to as an “external cloud environment 108” or collectively referred to as “external cloud environments 108”) and one or more internal cloud environments 110.

For instance, the classical networks 104 and the quantum networks 106 may collectively include a plurality of network nodes (not shown) comprising quantum channels and connected by a plurality of links. The network nodes may comprise, for instance, application programs, application programming interfaces (APIs), application servers, security servers, data repositories/lakes, routers, switches, load balancers, links, satellite nodes, other network nodes, and/or a combination thereof. A plurality of different end-to-end paths from any one network node to another network may be possible. Paths through the network may be optimized for physical path distance, number of hops in the path, utilization of the network nodes comprising the path endpoints and/or intermediate points (e.g., least busy endpoints and/or intermediate points, either individually or in the aggregate), or other parameters. For instance, even in classical terms, if a network node is at seventy percent utilization, any further linear increase in sustained utilization may result in exponential delay increases.

In one example, the optimizer 102 is a quantum reinforcement machine learning and quantum computation application. To this end, the optimizer 102 determines which delegated quantum computation protocols to invoke in order to delegate a quantum computation to one or multiple quantum computers, based on network topology and hybrid quantum-classical relative network performance metrics (which are described in greater detail in U.S. patent application Ser. No. 17/813,848, which is herein incorporated by reference in its entirety).

The optimizer 102 also manages the specific computations and distances to distribute the qubits required for the network cloud computations. The overhead induced by distributed computing is related to the complexity of the computation and the network topology. In one example, the further a computation is distributed in a network, the greater the overhead that is required for entanglement swapping. The overhead increases the time to execute a distributed computation and increases the number of qubits required, based on the size of the computation. In some examples, noisy links will require more re-generation and distribution of qubits to overcome noise losses. The optimizer 102 may manage the nearest-neighbor nodes for computations in such instances.

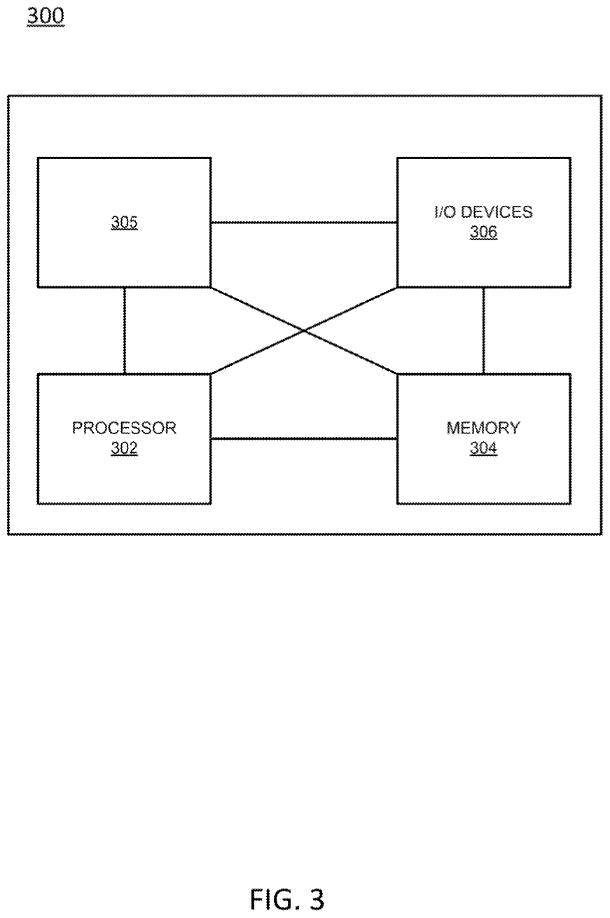

The optimizer 102 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the optimizer 102 may be configured to optimize fifth generation/sixth generation and next-generation hybrid quantum-classical networks. To this end, the optimizer 102 may comprise a distributed quantum-classical blockchain database 112 that stores quantum-classical network data and a quantum federated reinforcement learning (RL) agent 114 that functions as a decentralized resource control and allocation engine for the system 100. Details of the distributed quantum-classical blockchain database 112 and quantum federated RL agent 114 are discussed further below.

In one example, the distributed quantum-classical blockchain database 112 may comprise one or more databases that store quantum-classical network data, including network topology, tunable performance parameters, and/or other data. The distributed quantum-classical blockchain database 112 may utilize graph structures for semantic queries with nodes, edges, and properties to represent and store data. Nodes in the hybrid quantum-classical network may be represented as nodes in the distributed quantum-classical blockchain database 112, and network connections may be represented as edges in the distributed quantum-classical blockchain database 112.

Graph databases lend themselves to efficiently representing network topologies. Querying relationships within a graph database is a rapid process, because the relationships are perpetually stored within the database (i.e., the structure of the database models the network topology). Blockchains are distributed in secure databases that store data in a ledger. A graph blockchain has lower latency and compute requirements that a non-blockchain graph. In the present example, the graph blockchain database is hybrid quantum-classical in nature due to the fact that some operations and optimizations may be performed on a classical computer.

The distributed quantum-classical blockchain database 112 may further store records of delegated computing, quantum federated reinforcement learning with certified deletion, delegation and certified deletion of quantum-classical virtual network functions (VNFs), as well as records of which protocols were used for which computations and applications. In a further example, the distributed quantum-classical blockchain database 112 may store smart contracts, i.e., software primitives which manage the exchange of services and can use blockchain databases to manage delegated computing between untrusted users. In one example, the smart contracts may be stored in a separate database from the records of delegated computing, quantum federated reinforcement learning with certified deletion, delegation and certified deletion of quantum-classical VNFs. Alternatively, the smart contracts and the records of delegated computing, quantum federated reinforcement learning with certified deletion, delegation and certified deletion of quantum-classical VNFs may be stored in a single, common database.

In one example, the quantum federated reinforcement learning agent 114 relies on federated reinforcement learning, which is a decentralized, collaborative reinforcement learning method in which multiple distributed agents (e.g., “local agents”) are trained using local data that is not distributed or shared. The local agents cooperate to build a shared centrally orchestrated model (e.g., a “global model”) while maintaining the privacy of sensitive data. In one example, a global coordinator will, in the process of setting up a client-server-based learning system, create an initial model and send that initial model to a plurality of distributed local agents. Each local agent then trains the initial model using its own dataset, to create a unique local model. The local agents send updates of model parameters resulting from the local training to the global coordinator, which combines the updates using aggregation algorithms to generate a global model. The global coordinator may then distribute the global model to the local agents, which may repeat the local training using their respective datasets and the sending of updates to model parameters back to the global coordinator for further updating of the global model. This process may repeat until the model converges or until a maximum number of iterations have been performed. Local agents which join or are created after distribution of the initial model may access the most recent global model.

In one example, the quantum federated reinforcement learning agent 114 includes a reward function that is actuated from quantum-classical network node feedback before, during, and after application of parameter changes. The quantum federated reinforcement learning agent 114 learns optimal quantum adaptive topology, i.e., the computations and distance to distribute the qubits required for the network cloud computations. The quantum federated reinforcement learning agent 114 learns optimal behavior through reinforced rewards and penalties. Quantum reinforcement learning may extend the agent-network interaction quantum mechanically, where a plurality of network state identities is represented in superposition.

FIG. 1B, for instance, illustrates an example of the system 100 in which the optimizer 102 has distributed a plurality of virtual network functions (VNFs) 118₁-118ₘ (hereinafter individually referred to as a “VNF 118” or collectively referred to as “VNFs 118”) and a plurality of containerized network functions 120₁-120ₘ (hereinafter individually referred to as a “CNF 120” or collectively referred to as “CNFs 120”) to a plurality of quantum-classical compute applications 116₁-116ₘ (hereinafter individually referred to as a “compute application 116” or collectively referred to as “compute applications 116”) in a plurality of external and internal cloud environments. The VNFs 118 and/or CNFs 120 may provide 5G/6G+ core network functionality per Third Generation Partnership Project (3GPP) 5G standalone (SA) core functionality. The distribution and VNF usage may be based on network traffic demand, location, latency requirements, cost, and/or other parameters. In other words, the quantum federated reinforcement learning agent 114 may comprise a reinforcement learning algorithm that takes as an input at least one of: a traffic demand in the hybrid quantum-classical telecommunications network, locations of the plurality of external and internal cloud environments, a latency requirement of the hybrid quantum-classical telecommunications network, or a cost of the proposed network compute cloud configuration and generates as an output the distribution and VNF usage (which includes a delegation of at least one quantum function).

It should be noted that the system 100 has been simplified. Thus, those skilled in the art will realize that the system 100 may be implemented in a different form than that which is illustrated in FIG. 1A, or may be expanded by including endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the classical networks 104, quantum networks 106, external cloud (vendor) environments 108, and/or internal cloud environment 110 may comprise a content distribution network (CDN) having ingest servers, edge servers, and the like. In another example, a plurality of optimizers configured in a manner similar to the optimizer 102 may be deployed (and may cooperate, for example, to manage near-Earth (e.g., low Earth orbit, medium Earth orbit, or geostationary equatorial orbit) satellite-based quantum compute, storage, and applications). Thus, these and other modifications are all contemplated within the scope of the present disclosure.

In one example of the present disclosure, 5G, 6G, and next-generation telecommunications networks receive priority distribution, delegation, and certified deletion computing services via a quantum-classical compute cloud network optimizer such as the optimizer 102. These telecommunications networks may be directed to mobile and/or wireline networks within a plurality of use cases, including, for example: (1) prescriptively optimizing in real time a plurality of mobile network logical and physical resources to dynamically reallocate and reconfigure virtual network compute elements based on local-, regional-, and/or national-level disaster scenarios; (2) minimizing access latency, maximizing throughput, and maximizing network resiliency; (3) guaranteeing priority access and disallowing preemption once on the network; (4) dynamically routing network/compute traffic to respond to overload conditions; and (5) routing application and traffic based on application and/or compute requirements; among others.

In another example, the operator of a hybrid quantum-classical network that is managed according to the present disclosure may offer distribution, delegation, and certified deletion quantum computing as a service (QCaaS), quantum federated learning as a service (QFL) as a service, quantum virtualized network functions (QVNFs), and quantum containerized network functions (QCNF) as a service. Distributed quantum computing many link many quantum computers throughput a quantum network. Distributed quantum computing networks may provide quantum computing capacity at a scale that is impossible to achieve using a single quantum computer.

In another example, 5G and 6G networks may interoperate within a cloud computing environment, where delegated compute functions can be dynamically scheduled by the optimizer 102 across a plurality of internal and external data centers to continuously optimize available and predicted delegated compute resources, quantum entanglement swapping, quantum repeaters, and quantum entanglement distillation error detection.

In another example, quantum teleportation between two or more parties may be managed by the optimizer 102 (e.g., leveraging the quantum federated reinforcement learning agent 114). Teleportation is the primary method of transferring quantum information encoded in physical quantum states. Quantum teleportation allows two parties to transmit a qubit from one point to another point using quantum entanglement (i.e., a quantum property that enables qubit pairs that are proximal or separated over vast distances to remain inextricably state correlated). Two entangled qubits, when measured individually, can give random results; however, when considered as a holistic system, the states of each set of two entangled qubits are interdependent (their quantum states are no longer separate), with the net result that the overall system contains more information than the sum of the individual parts. Entangled states can either be bipartite (i.e., Bell pairs) or multipartite.

To accomplish quantum teleportation, the two parties need to begin with a shared Bell pair. Then, through measurement, the teleportation protocol consumes the Bell pair, resulting in the transmission of the desired qubit from the sending party to the receiving party. Teleportation, and the quantum communication enables by teleportation, is one of the fundamental applications of quantum networks. While the goal of classical networks is to distribute information, the goal of quantum networks is to distribute entanglement. Quantum teleportation is the protocol for using that entanglement to transmit quantum states.

In another example, multipartite states, including the tripartite Z-states and W-states (which are two inequivalent states of a maximally entangled class), may be managed by the optimizer 102 (e.g., leveraging the quantum federated reinforcement learning agent 114). Z-states and W-states have different properties and are two different communication resources for networks. Z-states guarantee inherent symmetry within measurements between the different parties, which is valuable for applications that require consensus or synchronization. W-states are valuable for breaking symmetry within parties, which enables distributed resource access applications. A Z-state of three or more qubits cannot be converted into an equal sized W-state by local quantum operations. W-states are not maximally connected and exhibit persistence properties that outperform Z-states. However, W-states are more robust to X-noise.

In another example, local storage (e.g., on quantum repeaters, end nodes, or the like) of entangled and/or purified qubits and/or multidimensional qubits could be managed by the optimizer. As an example, the optimizer 102 may make use of quantum entanglement swapping. Direct transmission of quantum entangled qubits is extremely difficult over long distances due to loss in transmission. Quantum entanglement swapping provides an alternative to directly transmitting qubits that can overcome transmission losses, because long-range entanglement can be stitched together from shorter range qubit pairs. Quantum repeaters create long distance qubit entanglement by connecting short distance entangled qubit pairs. Initially, two entangled qubit pairs each have one qubit in a middle quantum repeater. An entanglement swap is performed on these qubits, which destroys the entanglement of the two pairs, but results in the remote qubits existing in an entangled state.

Entanglement distillation is a form of quantum error detection. In entanglement distillation multiple, low quality Bell pairs can be reduced to a single pair or a smaller number of higher quality pairs through testing protocols that consume some pairs. Entanglement distillation protocols offer a tradeoff between the fidelity of the target state and the probability of successful distillation.

In another example, the costs associated with qubit and/or multidimensional qubit transport, purification, and storage can be managed by the optimizer 102 and stored in the distributed quantum-classical blockchain database 112.

In another example, the optimizer 102 may manage quantum compute, storage, and applications data deletion on untrusted devices, using cryptographic primitives with certified deletion. These cryptographic primitives may enable a party holding a quantum ciphertext to generate a classical certificate confirming that the encrypted plaintext has been information theoretic deleted. In a further example, quantum federated reinforcement learning with certified deletion may combine quantum compute, storage, and application certified data deletion on untrusted devices with quantum federated reinforcement learning, where quantum federated reinforcement learning global model updates are uploaded to a global agent without uploading sensitive data. In this case, the data used to train the quantum federated reinforcement learning locally (e.g., by local agents) may be certified deleted on locals nodes to ensure the privacy of sensitive data.

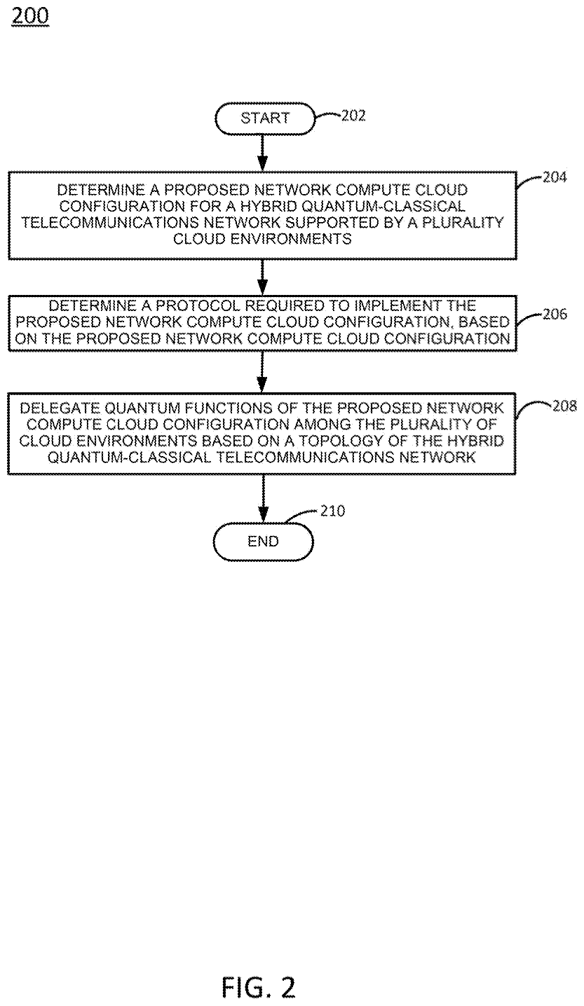

FIG. 2 illustrates a flowchart of an example method 200 for managing multi-vendor fifth generation/sixth generation and next-generation hybrid quantum-classical networks, in accordance with the present disclosure. In one example, steps, functions and/or operations of the method 200 may be performed by a device as illustrated in FIG. 1A, e.g., quantum-classical compute cloud network optimizer 102 or any one or more components thereof. In another example, the steps, functions, or operations of method 200 may be performed by a computing device or system 300, and/or a processing system 302 (e.g., having at least one processor) as described in connection with FIG. 3 below. For instance, the computing device 300 may represent at least a portion of the quantum-classical compute cloud network optimizer 102 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may determine a proposed network compute cloud configuration for a hybrid quantum-classical telecommunications network supported by a plurality of cloud environments.

As discussed above, in one example, the plurality of cloud environments may comprise a combination of quantum-classical cloud computing external (vendor) networks and internal networks. In one example, the proposed compute cloud configuration may be a configuration for a sub-network rather than an entire network.

In step 206, the processing system may determine a protocol that is required to implement the proposed network compute cloud configuration, based on a topology (e.g., quantum channels and classical channels) of the hybrid quantum-classical telecommunications network.

More specifically, in one example, the protocol is determined based on the end-to-end connectivity between nodes in the hybrid quantum-classical telecommunications network. For instance, in one example, if the processing system determines that the required or available end-to-end network connectivity between nodes is classical online communication-quantum offline communication, then the processing system determines that the protocol required is the Prepare and Send Universal Blind Quantum Computation protocol.

The Prepare and Send Universal Blind Quantum Computation protocol requires one-time quantum communication at the start or at the end of the protocol, with continuous classical communication throughout execution of the protocol. The Prepare and Send Universal Blind Quantum Computation protocol also achieves the functionality of secure client-server delegated quantum computation by assigning quantum computation to an untrusted device, while maintaining the privacy of the input, output, and computation of the client. The client requires the ability to prepare and send quantum states, while the server requires the possession of a device with quantum memory, measurement, and entanglement generation technology.

In another example, if the processing system determines that the required or available end-to-end network connectivity between nodes is classical online communication-quantum online communication, then the processing system determines that the protocol required is the Measurement Only-Universal Blind Quantum Computation protocol.

The Measurement Only-Universal Blind Quantum Computation protocol requires continuous quantum communication throughout execution of the protocol and provides the properties of correctness, blindness, and universality. The Measurement Only-Universal Blind Quantum Computation protocol also achieves the functionality of secure client-server delegated quantum computation by assigning quantum computation to an untrusted device while maintaining the privacy of the input, output, and computation of the client. The client requires the ability to prepare and send quantum states, while the server requires the possession of a device with quantum memory, measurement, and entanglement generation technology.

In another example, if the processing system determines that the required or available end-to-end network connectivity between nodes is classical offline communication-quantum offline communication, then the processing system determines that the protocol required is the Pseudo-Secret Random Qubit Generator protocol.

The Pseudo-Secret Random Qubit Generator protocol enables fully classical parties to generate secret, single qubit states using only public classical channels and a single quantum server. The functionality of the Pseudo-Secret Random Qubit Generator protocol could be used to replace a quantum channel completely, such that a classical client can perform various quantum applications over a classical network connected to a quantum server. An application of this functionality might include carrying out delegated quantum computation by classical online communication only (i.e., using classical communication throughout the protocol), without any quantum communication. This would allow a fully classical client to instruct the quantum server to generate random single qubit states, such that the client has complete knowledge of the state of the qubit prepared, but the server does not. The Pseudo-Secret Random Qubit Generator protocol can be used for Universal Blind Quantum Computation, Verifiable Universal Blind Quantum Computation, and for other protocols including quantum money, quantum digital signatures, and the like which require sharing of a user's private quantum key over a quantum channel.

In another example, if the processing system determines that the required or available end-to-end network connectivity between nodes is classical online communication-no quantum communication, then the processing system determines that the protocol required is the Prepare and Send Fully Homomorphic Encryption protocol.

The Prepare and Send Fully Homomorphic Encryption protocol achieves the functionality of secure client-server delegated quantum computation through quantum fully homomorphic encryption (QFHE), which requires quantum offline and classical offline communication. QFHE allows the client to encrypt quantum data in such a way that the server can carry out any arbitrary quantum computations on the encrypted data, without having to interact with the encrypting party (i.e., the client). QFHE hides the input and output of a computation, while the server is permitted to choose the unitary operation required for the computation. Thus, the circuit is known to the server, while efforts can be made to hide the circuit from the encrypting party. Based on the existence of the classical homomorphic encryption (HE) scheme, QFHE provides the properties of correctness, compactness, and full homomorphism. QFHE can be used to keep the circuit private to the server and hidden from the client, unlike Universal Blind Quantum Computation (where the circuit is private to the client and hidden from the server).

In another example, if the processing system determines that the required or available end-to-end network connectivity between nodes is classical offline communication-no quantum communication, then the processing system determines that the protocol required is the Classical Fully Homomorphic Encryption for Quantum Circuits protocol.

The Classical Fully Homomorphic Encryption for Quantum Circuits protocol hides the input and output of the client and achieves the functionality of delegated quantum computation through a method which involves fully classical offline computation and no quantum communication. The Classical Fully Homomorphic Encryption for Quantum Circuits protocol uses only the classical HE scheme (discussed above) to evaluate quantum circuits for classical input and output. The Classical Fully Homomorphic Encryption for Quantum Circuits protocol allows a fully classical client to encrypt its data, such that the server can carry out any arbitrary quantum computation on the encrypted data without having any knowledge of the client's inputs. The Classical Fully Homomorphic Encryption for Quantum Circuits protocol hides the input and output of a computation, while the server is permitted to choose the unitary operation (e.g., any quantum gate) required for the computation. Quantum offline communication would be required, however, if the client's input and output are quantum.

All of the above-described protocols require the server to be a quantum memory network stage node. However, with respect to the client, the Prepare and Send Universal Blind Quantum Computation protocol only requires the client to prepare and send quantum states, while the Measurement-Only Universal Blind Quantum Computation protocol only requires the client to receive and measure quantum states. Thus, the client belongs to a simple prepare and measure network stage node. This information is useful if there are only a few nodes having advanced technologies such as quantum memory.

Referring back to FIG. 2, in step 208, the processing system may delegate a quantum function of the proposed network compute cloud configuration among the plurality of cloud environments, using the protocol(s) (as determined in step 206).

In one example, the quantum function may include one or more of: a quantum computation, quantum federated reinforcement learning, a quantum virtualized network function, or a quantum containerized network function.

Having delegated at least one quantum function, the method 200 may end in step 210. However, all or part of the method 200 may be repeated as new network compute cloud configurations for the hybrid quantum-classical telecommunications network are proposed.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Examples of the present disclosure therefore provide for the delegation and certified deletion of quantum federated reinforcement learning to cloud quantum compute and storage over classical-quantum networks with the security advantages of quantum networks.

Further examples of the present disclosure provide distribution, delegation, and certified deletion of compute, storage, and applications to cloud quantum compute and storage over classical-quantum networks with the security advantages of quantum networks. Distributed quantum computing can be used to link multiple quantum computers through a quantum network. Distributed quantum computing networks provide quantum computing capacity at a scale that is not possible to achieve with individual quantum computers.

Further examples of the present disclosure provide delegation and certified deletion of quantum-classical containerized network functions, virtual network functions, and associated data. Quantum machine learning can automatically adjust network functions based on demand. For instance, if a CNF or VNF is needed at a local node for processing, the demand can be predicted and serviced by downloading the required CNF or VNF (either a priori or in real time). Once the processing load decreases, the downloaded CNF or VNF can be deleted or idled.

Further examples of the present disclosure provide adaptive topology to modify a hybrid quantum-classical network “on the fly” to bypass compromised nodes or parts of the network that are no longer active.

FIG. 3 depicts a high-level block diagram of a computing device or processing system specifically programmed to perform the functions described herein. As depicted in FIG. 3, the processing system 300 comprises one or more hardware processor elements 302 (e.g., at least one central processing unit (CPU), a microprocessor, or a multi-core processor), a memory 304 (e.g., random access memory (RAM) and/or read only memory (ROM)), a module 305 for managing multi-vendor fifth generation/sixth generation and next-generation hybrid quantum-classical networks, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for managing multi-vendor fifth generation/sixth generation and next-generation hybrid quantum-classical networks (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for managing multi-vendor fifth generation/sixth generation and next-generation hybrid quantum-classical networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
determining, by a processing system including at least one processor, a proposed network compute cloud configuration for a hybrid quantum-classical telecommunications network supported by a plurality of cloud environments;
determining, by the processing system, a protocol that is required to implement the proposed network compute cloud configuration, based on a topology of the hybrid quantum-classical telecommunications network; and
delegating, by the processing system, a quantum function of the proposed network compute cloud configuration among the plurality of cloud environments, using the protocol.

2. The method of claim 1, wherein the processing system is part of a quantum-classical compute cloud network optimizer.

3. The method of claim 2, wherein the quantum-classical compute cloud network optimizer includes a distributed quantum-classical blockchain database and a quantum federated reinforcement learning agent.

4. The method of claim 3, wherein the distributed quantum-classical blockchain database stores network data for the hybrid quantum-classical telecommunications network.

5. The method of claim 3, wherein the quantum federated reinforcement learning agent takes as an input at least one of: a traffic demand in the hybrid quantum-classical telecommunications network, locations of the plurality of cloud environments, a latency requirement of the hybrid quantum-classical telecommunications network, or a cost of the proposed network compute cloud configuration and generates as an output a delegation of the quantum function.

6. The method of claim 1, wherein the plurality of cloud environments includes at least one external cloud network and at least one internal cloud network.

7. The method of claim 1, wherein the protocol is determined based on an end-to-end connectivity between nodes of the hybrid quantum-classical telecommunications network.

8. The method of claim 7, wherein the end-to-end connectivity comprises classical online communication-quantum offline communication.

9. The method of claim 8, wherein the protocol comprises a prepare and send universal blind quantum computation protocol.

10. The method of claim 7, wherein the end-to-end connectivity comprises classical online communication-quantum online communication.

11. The method of claim 10, wherein the protocol comprises a measurement only-universal blind quantum computation protocol.

12. The method of claim 7, wherein the end-to-end connectivity comprises classical offline communication-quantum offline communication.

13. The method of claim 12, wherein the protocol comprises a pseudo-secret random qubit generator protocol.

14. The method of claim 7, wherein the end-to-end connectivity comprises classical online communication-no quantum communication.

15. The method of claim 14, wherein the protocol comprises a prepare and send fully homomorphic encryption protocol.

16. The method of claim 7, wherein the end-to-end connectivity comprises classical offline communication-no quantum communication.

17. The method of claim 16, wherein the protocol comprises a classical fully homomorphic encryption for quantum circuits protocol.

18. The method of claim 1, wherein the quantum function comprises at least one of: a quantum computation, quantum federated reinforcement learning, a quantum virtualized network function, or a quantum containerized network function.

19. A non-transitory computer-readable medium storing instructions which, when executed by a processing system including at least one processor, cause the processing system to perform operations, the operations comprising:
determining a proposed network compute cloud configuration for a hybrid quantum-classical telecommunications network supported by a plurality of cloud environments;
determining a protocol that is required to implement the proposed network compute cloud configuration, based on a topology of the hybrid quantum-classical telecommunications network; and
delegating a quantum function of the proposed network compute cloud configuration among the plurality of cloud environments, using the protocol.

20. A device comprising:
a processing system including at least one processor; and
a non-transitory computer-readable medium storing instructions which, when executed by the processing system, cause the processing system to perform operations, the operations comprising:
determining a proposed network compute cloud configuration for a hybrid quantum-classical telecommunications network supported by a plurality of cloud environments;
determining a protocol that is required to implement the proposed network compute cloud configuration, based on a topology of the hybrid quantum-classical telecommunications network; and
delegating a quantum function of the proposed network compute cloud configuration among the plurality of cloud environments, using the protocol.
